(19) United States
(12) Patent Application Publication
(10) Pub. No.: US 2022/0259070 A1
(43) Pub. Date: Aug. 18, 2022

(54) ENHANCED MECHANICAL DEWATERING OF A SLURRY

(71) Applicant: Phibion Pty. Ltd., Queensland (AU)

(72) Inventors: Leon Munro, Queensland (AU); David Smirk, Queensland (AU)

(21) Appl. No.: 17/609,807

(22) PCT Filed: May 29, 2020
(86) PCT No.: PCT/AU2020/050547

§ 371 Date: Nov. 9, 2021

(30) Foreign Application Priority Data
May 30, 2019 (AU) 2019901868

(51) Int. Cl. C02F 1/00; C02F 11/121; B60F 3/00; B63H 19/08; B62D 57/036

(52) U.S. Cl. CPC C02F 1/008; C02F 11/121; C02F 2201/008; B63H 19/08; B62D 57/036; B60F 3/0023

(57) ABSTRACT

The present disclosure relates to methods and a vehicle for enhancing the mechanical dewatering of a slurry. In one aspect, the disclosure concerns a method for enhanced dewatering of a settling pond with a mechanical dewatering vehicle including: measuring one or more properties of a slurry to be deposited in the settling pond; determining a buoyancy profile for the vehicle, based on the one or more properties measured and one or more properties of the vehicle, such that the vehicle is neutrally buoyant in the slurry when deposited in the settling pond; and determining an optimal slurry depth for the slurry to be deposited in the settling pond such that the vehicle is able to maintain substantially shear-free traction as the vehicle traverses the slurry.

### TECHNICAL FIELD

The present disclosure relates to a system, methods and a vehicle for enhancing the mechanical dewatering of a slurry.

### BACKGROUND

Tailings, also called slimes, leach residue, or slickens, are the waste materials left over after the mechanical and chemical processes used to extract a desirable fraction from a non-desired fraction of a mined ore.

Dredge spoils are generally underwater sediment materials (such as, e.g., sand, silt and clay material or materials) excavated during dredging activities, such as, e.g., the maintenance of shipping transport routes and port facilities.

Typically, both tailings and spoils (collectively hereafter referred to as “slurries”) have a semi-liquid consistency containing particles of solid material (e.g., ground rock, process effluents and/or sediment material) ranging in size from a grain of sand to a few microns, and fluid.

Usually, mine processing plants, port authorities and other processing facilities dispose of slurries in a disposal facility in the form of a tailings dam, pond or similar impoundment (collectively hereafter referred to as a “settling pond”).

Over the last century, the volume of slurries being generated has exponentially increased. Accordingly, many techniques are being employed to try and reduce the area required for an effective settling pond, decrease dewatering time and/or increase the load of existing settling ponds. Typically, such techniques involve enhancing, or attempting to enhance, consolidation and/or dewatering rates through chemical and/or mechanical means, since natural dewatering can take several years, is unpredictable and leads to variable outcomes.

The inventors have previously disclosed a method for the enhanced mechanical dewatering of a slurry through WO2016/134424, which is herein incorporated by reference in its entirety. However, the inventors have recognised that the disclosed process is not optimal and that the dewatering of a slurry can be further enhanced.

It will be clearly understood that, if a prior art publication is referred to herein, this reference does not constitute an admission that the publication forms part of the common general knowledge in the art in Australia or in any other country.

### Summary of Disclosure

Embodiments of the present disclosure provide a system, methods and a vehicle for enhanced dewatering of a slurry, which may at least partially overcome at least one of the abovementioned disadvantages or provide the public with a useful or commercial choice.

According to a first aspect of the present disclosure, there is provided a system for enhanced dewatering of a settling pond with a mechanical dewatering vehicle, said system including:

an external processing device; and

at least one measuring device for measuring properties of a slurry to be deposited in the settling pond, wherein the external processing device includes at least one processor and a memory and is programmed to:
determine a buoyancy profile for the vehicle, based on the one or more properties measured and one or more properties of the vehicle, such that the vehicle is neutrally buoyant in the slurry when deposited in the settling pond; and
determine an optimal slurry depth for the slurry to be deposited in the settling pond such that the vehicle is able to maintain substantially shear-free traction as the vehicle traverses the slurry.

According to a second aspect of the present disclosure, there is provided a method of enhanced dewatering of a settling pond with a mechanical dewatering vehicle, said method including:

measuring one or more properties of a slurry to be deposited in the settling pond;

determining a buoyancy profile for the vehicle, based on the one or more properties measured and one or more properties of the vehicle, such that the vehicle is neutrally buoyant in the slurry when deposited in the settling pond; and

determining an optimal slurry depth for the slurry to be deposited in the settling pond such that the vehicle is able to maintain substantially shear-free traction as the vehicle traverses the slurry.

According to a third aspect of the present disclosure, there is provided a method of modifying a mechanical dewatering vehicle for enhanced dewatering of a slurry, said method including:

measuring one or more properties of the slurry;

determining a buoyancy profile for the vehicle, based on the one or more properties measured and one or more properties of the vehicle, such that the vehicle is neutrally buoyant in the slurry; and

modifying the vehicle, based on the buoyancy profile determined, such that the vehicle is able to maintain substantially shear-free traction as the vehicle traverses the slurry.

According to a fourth aspect of the present disclosure, there is provided a dewatering vehicle for mechanically dewatering a slurry when modified by the method of the third aspect.

According to a fifth aspect of the present disclosure, there is provided a dewatering vehicle for mechanically dewatering a slurry, said vehicle having been modified based on a buoyancy profile determined for the vehicle to be neutrally buoyant in the slurry and maintain substantially shear-free traction as the vehicle traverses the slurry.

Advantageously, the present disclosure provides a system and methods for the enhanced mechanical dewatering of a slurry in a settling pond that offers maximum efficiency/productivity of the mechanical dewatering vehicle in its application. Specifically, by modifying the vehicle to suit the specific slurry material being dewatered by determining a neutral buoyancy profile and an optimum slurry depth, the vehicle provides an optimal balance of speed and operating depth with substantially shear-free traction, the latter being a major contributing factor to inefficient dewatering operations.

Furthermore, until this disclosure, mechanical dewatering vehicles were typically not optimised to suit the particular slurry being treated. Rather, vehicle designs were approximate with any efficiency benefits being defined by how an operator used the vehicle. In contrast, the present disclosure enables the vehicle to be specifically tailored to suit the slurry being dewatered in advance in slurry materials with no prior dewatering operational history. This proactive approach saves time and resources and providing rigorous means of confirming safe operation and capabilities before implementation of the vehicle.

As used herein, the term “settling pond” refers to any reservoir open to the atmosphere and used to collect slurry-like material. The term encompasses tailings dams, waterlogged marshes, dredge spoil impoundments and the like. The settling pond may include a base substrate referred to as a “base layer” atop of which the slurry is deposited. In some embodiments, the base substrate may include previously dewatered slurry.

As used herein, the term “slurry” and variations such as “slurries” refer to emplaced tailings, slimes, leach residues, slickens, dredge spoils and other like material and/or materials having slurry-like properties.

As used herein, the term “dewatering vehicle” may encompass any vehicle configured to traverse over slurries and slurry-like mediums and provide low ground pressure, preferably the vehicle may be an Archimedes Screw Tractor.

Generally, the vehicle may include a chassis and at least two auger-like cylinders fitted to the chassis. Each cylinder may include at least one outwardly extending helical spiral flange. Each cylinder and helical spiral flange may collectively be referred to hereafter as a “scroll”.

Typically, the vehicle may be propelled by rotation of the scrolls such that the respective outwardly extending helical spiral flanges may engage with a medium through or over which the vehicle traverses, preferably a base layer of the settling pond.

Usually, the at least two scrolls may extend beneath and/or along each longitudinal side of the chassis. Of the at least two scrolls, a first said scroll may have the at least one helical spiral flange extending clockwise along a length of the scroll, and a second said scroll may have the at least one helical spiral flange extending anti-clockwise along the length of the scroll.

The vehicle may be buoyant regardless of the medium through or over which it traverses. The buoyancy of the vehicle may be at least partially attributable to the scrolls, which are substantially hollow.

The vehicle may further include one or more motors to counter-rotate the scrolls such that a first scroll rotates clockwise and a second scrolls rotates counter-clockwise. Advantageously, any lateral movement of the vehicle may be cancelled out by counter-rotation of the scrolls thereby allowing the vehicle to be propelled either forwards or backwards in a direction substantially parallel with the axis of rotation of the scrolls.

In use, the vehicle facilitates in the mechanical dewatering of slurries through the dewatering and subsequent consolidation of slurry material under the loading weight of the vehicle as it traverses over the slurry, and the creation of surface drainage channels (i.e., scroll lines) by the passage of the scrolls of the vehicle. Generally, the drainage channels are orientated along the angle of repose of the slurry to afford natural drainage under gravity. Typically, as the slurry material consolidates, fluid is released into the scroll lines and drains away.

The vehicle may preferably further include a vehicle tracking system to assist in tracking the vehicle in operation. Generally, the tracking system may include a GPS logger unit or GPS tracker or other hardware/software to assist in tracking of the vehicle, preferably offsite tracking.

As indicated above, the system and methods of the present disclosure include a step of measuring one or more properties of the slurry to be deposited into the settling pond. These properties may generally include any property necessary for determination of a buoyancy profile for the vehicle to be neutrally buoyant in the slurry when deposited and/or for determining a shear strength of the slurry material. The at least one measuring device may include any suitable device for measuring the one or more properties.

For example, in some embodiments, the one or more properties may include any one of solids density, liquor density, solids flow rate, liquor flow rate, slurry flow rate, slurry density, and slurry shear strength. In other embodiments, the one or more properties may include any one of initial slurry density (preferably initial settled slurry density), initial shear strength, initial slurry viscosity, initial moisture content, initial particle size distribution (“PSD”), and initial residue solids content. Preferably, the one or more properties may at least include slurry density and slurry shear strength or parameters that enable the slurry density and/or shear strength to be calculated.

Typically, the measuring may include measuring properties from at least one sample taken from the slurry, preferably at least two samples.

In some embodiments, the measuring may be performed immediately on the at least one sample. In other embodiments, the measuring may be performed after the at least one sample have been allowed to sit for a period of time.

For example, the measuring may be delayed until the at least one sample has reached “settled density” or a density at which excess fluid is no longer being shed by consolidating forces at a rate equal to the vertical permeability of the slurry. In some such embodiments, the at least one sample of slurry may be allowed to consolidate for a period of between 24 to 72 hours or longer.

In some embodiments, the measuring may include using a hand-held shear vane shear tester together with slurry coring to develop a density/shear strength curve. Once sufficient measurements have been recorded or taken, the shear vane measurements may be used to infer slurry density.

In some embodiments, the measuring may include taking one or more samples to determine particle size distribution. This may be measured by way of, inter alia, sieve analysis, air elutriation analysis, photoanalysis, optical counting methods, electroresistance counting methods, sedimentation techniques, laser diffraction methods (such as, e.g., laser obscuration time (“LOT”) or time of transition (“TOT”)), acoustic spectroscopy or ultrasound attenuation spectroscopy.

In some embodiments, the measuring may include obtaining a mineralogical assessment or analysis of one or more samples to determine mineral composition and mineral structure in the slurry, preferably to define the presence of clay fraction materials. The mineralogical assessment or analysis may be performed by, but is not limited to, powder X-ray diffraction, scanning electron microscopy (“SEM”) with associated energy dispersive micro analysis (EDA), optical microscopy and/or petrographic analysis.

Once the measuring has been completed, a buoyancy profile for the vehicle may be determined at which the vehicle may be neutrally buoyant within the slurry, when deposited in the settling pond.

Any suitable buoyance profile may be determined at which the average density of the vehicle is substantially equal to the density of the slurry in which it is, or will be, at least partially immersed. Typically, neutral buoyancy may be achieved when a buoyant force acting on the vehicle balances out forces that would otherwise cause the vehicle to sink or rise in the slurry. Preferably, a suitable buoyancy profile may be determined at which the vehicle may maintain substantially shear-free traction along a base layer of the settling pond.

As used herein “shear-free traction” may refer to traction of the vehicle through a slurry material while imparting substantially zero shear stress to the slurry material. In preferred embodiments, substantially shear-free traction may refer to traction of a neutrally buoyant vehicle along the base layer of the settling pond in which only the helical flanges of the scrolls of the vehicle engage with the base layer. Preferably, the shear-free traction may include traction along the base layer without re-pulping/re-mixing/re-saturation of the base layer of the settling pond. Importantly, this is a key point of difference with the inventors' earlier disclosures, which taught maximal penetration of the scrolls within the slurry regardless of the depth of the slurry and the shear stress that the base layer was exposed to by the scrolls.

Generally, the one or more properties of the vehicle considered when determining the buoyancy profile may include the mass of the vehicle, the volume of the vehicle, the slurry-engaging surface area of the vehicle, and/or the dimensions and/or volume of the scrolls.

In some embodiments, at least some of the properties of the vehicle may correspond to one or more features of the vehicle capable of being modified so as to enable the vehicle to conform with, or meet, the neutral buoyancy profile determined.

Typically, the one or more features of the vehicle modified may include any suitable feature that has an effect on the weight, density and/or buoyancy of the vehicle, preferably while maintaining vehicle stability. In some embodiments, the one or more features of the vehicle may be modified to provide the vehicle with a desired operating speed and/or traction, preferably while maintaining vehicle stability.

A desired traction may preferably be a maximum substantially shear-free traction along the base layer of the settling pond.

A desired operating speed may preferably be a maximum operating speed that the vehicle is capable of while maintaining substantially shear-free traction as it traverses the slurry, preferably along the base layer of the settling pond.

In determining a desired traction and/or operating speed, a required torque may be determined for rotation of the scrolls in the slurry material. Once the required torque is determined, an estimate of the required hydraulic power may be determined as well as the engine power required to supply the required hydraulic power.

Typically, the desired operating speed may be a maximum speed at which the vehicle is capable of traversing the slurry without re-pulping, re-mixing and/or re-saturating the slurry material and/or base layer through, or over, which it traverses.

Generally, the vehicle may use a lower operating speed when dewatering a slurry with a lower density and shear strength than when dewatering a slurry with a higher density and shear strength.

Usually, the desired operating speed of the vehicle may be between about 0.1 m·s⁻¹ and 1 m·s⁻¹.

In some embodiments, the one or more modifiable features of the vehicle may include the addition or removal of a mass from the vehicle, such as, e.g., one or more weights or counter-weights.

In other such embodiments, the one or more features may include the use of a ballast-like system provided on the vehicle. The system may include one or more tanks located on the vehicle and configured to hold a volume of material, preferably a fluid or a fine particulate, to alter the mass and thereby the buoyancy of the vehicle.

In yet other preferred embodiments, the one or more features may include substituting the scrolls of the vehicle to alter the buoyancy of the vehicle. For example, in scenarios in which the vehicle needs to be less buoyant, the vehicle may be fitted with smaller scrolls having a smaller hollow internal volume. Conversely, in scenarios in which the vehicle needs to be more buoyant, the vehicle may be fitted with larger scrolls having a larger hollow internal volume.

In yet some such preferred embodiments, the one or more features may include features of the scrolls. For example, modifications to increase or decrease the number, the shape and/or the pitch of the helical spiral flange or portions thereof that extends along a length of each scroll may alter the speed and/or traction provided by the scroll and/or the weight of each scroll and thus the buoyancy of the vehicle. Advantageously, this enables engagement between the helical spiral flange or portions thereof and a base layer of the settling pond to be maximised but is limited by a minimum distance between the flanges or portions thereof that do not hold slurry material therebetween thereby negating traction that can be gained.

For example, in some such embodiments, the height of the helical spiral flange or a portion thereof may be altered to alter the traction and/or speed provided by the scroll.

As indicated above, the system and methods include determining an optimal slurry depth for the slurry to be deposited in the settling pond such that the vehicle is able to maintain substantially shear-free traction as the vehicle traverses the slurry, preferably along a base layer of the settling pond.

Generally, an optimal slurry depth may be a depth at which the scrolls of the vehicle may maintain substantially shear-free traction with the base layer while being neutrally buoyant within the deposited slurry. Typically, the optimal slurry depth may coincide with a depth at which the helical flanges of the scrolls of the vehicle are able to maintain engagement with the base layer of the settling pond but not a depth at which a remainder of the scrolls engage with the base layer.

In some embodiments, instances may arise in which the slurry depth exceeds the operating depth capability of the vehicle. In such embodiments, the vehicle may still be used to dewater the slurry albeit less effectively at least partially due to reduced traction, reduced operating speed and/or a reduced consolidating force being applied by the vehicle. Typically, the vehicle in such scenarios is still capable of traversing the slurry in a substantially shear-free traction but at a reduced operating speed.

However, in preferred embodiments and as indicated above, at an optimal slurry depth, the helical flanges of the scrolls of the neutrally buoyant vehicle are able to gain optimal substantially shear-free traction with the base layer of the settling pond and propel the vehicle through the slurry at an optimal operating speed.

A person skilled in the art will appreciate that over time the slurry depth will decrease as the deposited slurry dewaters. Accordingly, in some embodiments, the method may further include maintaining the slurry at the optimal depth determined. The maintaining may include depositing further slurry into the settling pond as needed to maintain the optimal slurry determined.

In some embodiments, the system and methods of the disclosure may further include testing the vehicle for static and/or dynamic stability prior to deploying the vehicle on the slurry.

Testing and modelling of modified vehicles may be at least partially undertaken or assisted with the use of designing and testing software.

In some embodiments, the system and methods of the disclosure may further include periodically re-measuring the one or more properties of the slurry to at least monitor the dewatering process, preferably to monitor when a target slurry density and/or shear strength is achieved or reached.

The external processing device may include a computer, a tablet, a smart phone, a smart watch or a PDA, for example. Generally, the device may include at least one display and one or more keys, buttons or switches for a user to input the properties measured. In some embodiments, the display may be a touchscreen.

The device may preferably include a communications module for connecting the device to other devices, such as, e.g., a remotely accessible server. For example, operations personnel onsite may measure the one or more properties of the slurry and input values for the properties measured into the external processing device for uploading to a remotely accessible service and further processing offsite.

The communications module may be in the form of a wireless module, such as, e.g., a wireless network interface controller, such that the device may wireless connect to other devices via a wireless network (e.g., Wi-Fi (WLAN) communication, Satellite communication, RF communication, infrared communication, or Bluetooth™).

The memory of the device may include one or more programs and/or data, such as, e.g., weight parameters of different vehicle configurations and components thereof and their associated buoyancy profiles, and height and size parameters of different vehicle configurations and components thereof. The memory may further include one or more look-up tables for determining a required buoyancy profile based on inputted said one or more properties measured from the slurry.

Any of the features described herein can be combined in any combination with any one or more of the other features described herein within the scope of the disclosure.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the disclosure may be discerned from the following Detailed Description which provides sufficient information for those skilled in the art to perform the disclosure. The Detailed Description is not to be regarded as limiting the scope of the preceding Summary of Disclosure in any way. The Detailed Description will make reference to a number of drawings as follows:

FIG. 1 is a line drawing of a mechanical dewatering vehicle;

FIG. 2 is an illustration of a system for enhanced dewatering of a settling pond according to an embodiment of the present disclosure;

FIG. 3 is a flowchart showing steps in a method for enhanced dewatering of a settling pond according to an embodiment of the present disclosure; and

FIG. 4 is a flowchart showing steps in a method of modifying a mechanical dewatering vehicle for enhanced dewatering of a settling pond according to an embodiment of the present disclosure.

### DETAILED DESCRIPTION

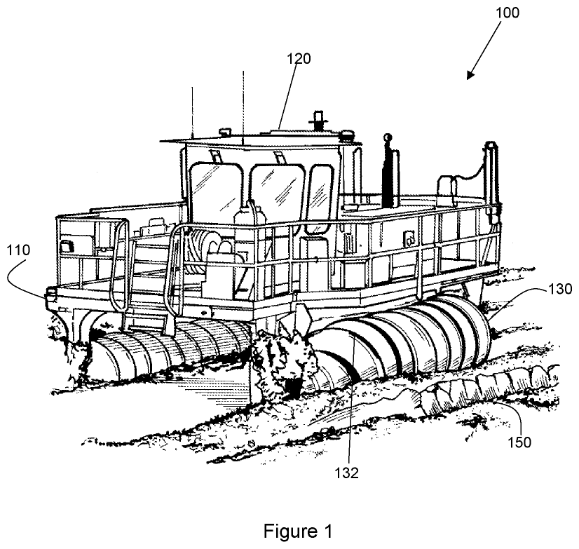

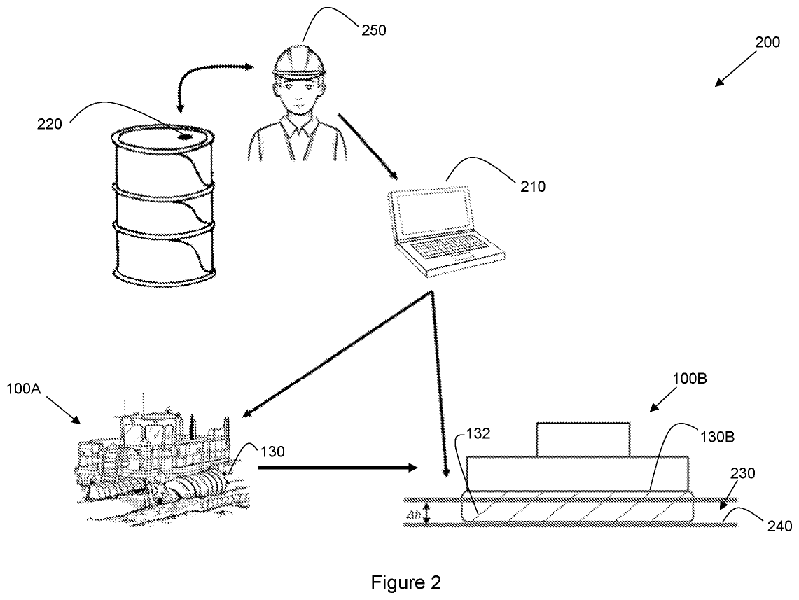

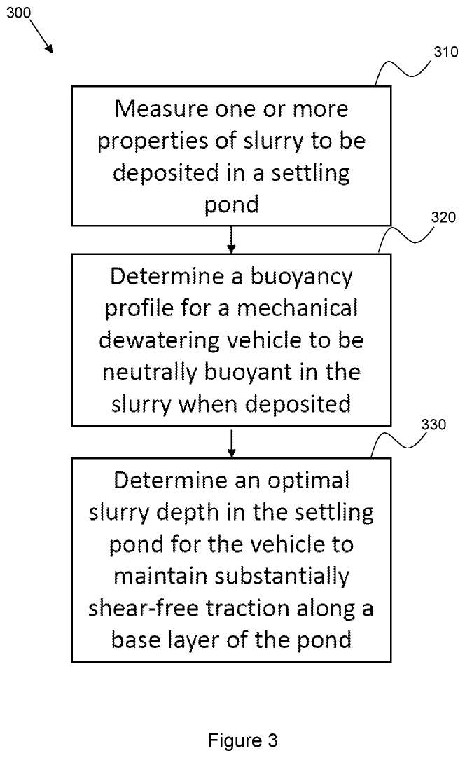

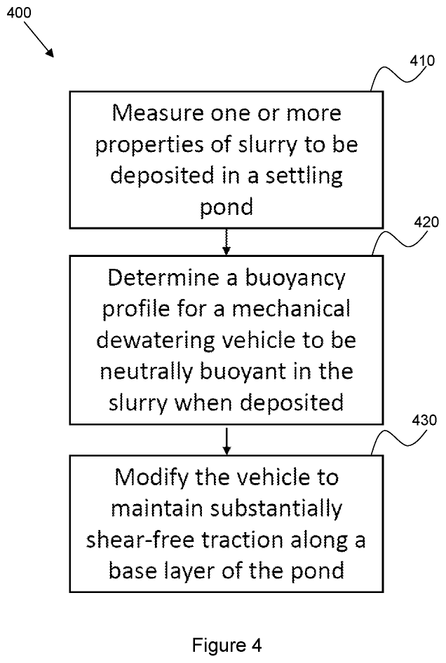

FIG. 1 shows an Archimedes Screw Tractor vehicle (100) used for the mechanical dewatering of slurries. FIG. 2 shows a system (200) for enhanced dewatering of a settling pond. Lastly, FIGS. 3 and 4 respective show a method (300) for enhanced dewatering of a settling pond and a method (400) of modifying a vehicle (100) for enhanced dewatering of a settling pond.

Referring to FIG. 1, the vehicle (100) includes a chassis (110), a cabin (120) and two scrolls (130) configured to rotate and propel the vehicle (100). Each scroll (130) has at least one outwardly extending helical spiral flange (132) configured to engage with the medium through or over which the vehicle (100) traverses.

The two scrolls (130) extend beneath and/or along each longitudinal side of the chassis (110). One scroll (130) has at least one helical spiral flange (132) that extends clockwise along a length of the scroll (130). The other scroll (130) has at least one helical spiral flange (132) that extends counter-clockwise along a length of the scroll (130).

The vehicle (100) is buoyant at least partially due to the scrolls (130), which are hollow.

In use, the scrolls (130) are counter-rotated to propel the vehicle (100). That is, one scroll (130) is rotated clockwise and the other scroll (130) is rotated counter-clockwise. Each scroll (130) is driven by an engine.

The vehicle (100) facilitates in the mechanical dewatering of slurries through consolidation of the slurry material under the loading weight of the vehicle (100) as it traverses over, or through, the slurry. The vehicle (100) further facilitates in the mechanical dewatering of slurries through the formation of scroll lines (i.e., drainage channels; 150) by passage of the scrolls (130) of the vehicle (100). As the slurry material is consolidated, fluid is released into the scroll lines (150) and drains away.

Referring to FIG. 2, the system (200) includes: an external processing device (210); and a measuring device (not shown) for measuring properties of a slurry sample (220) obtained from a slurry (230) to be deposited in a settling pond. The external processing device (210) is programmed to determine a buoyancy profile the vehicle (100A) based on the one or more properties measured and the properties of the vehicle (100A), such that the vehicle (100B) is neutrally buoyant in the slurry (230) when deposited in the settling pond. The external processing device (210) is further programmed to determine an optimal slurry depth (shown as Δh) for the slurry (230) to be deposited in the settling pond such that the vehicle (100B) is able to maintain substantially shear-free traction along a base layer (240) of the settling pond.

The measuring includes measuring properties from at least one sample (220) taken from the slurry (230) before it is deposited in the settling pond. The measuring is performed after the sample (220) has reached “settled density” or a density at which excess fluid is no longer being shed by consolidating forces at a rate equal to the vertical permeability of the slurry (230). The properties measured include slurry density and shear strength or properties from which slurry density and/or shear strength can be derived.

The measuring includes using a measuring device, such as, e.g., a hand-held shear vane shear tester, together with a slurry coring device to develop a density/shear strength curve from which at least slurry density can be inferred, once a suitable number of measurements have been obtained.

Once the measuring has been undertaken, operations personnel (250) onsite input the properties into the device (210) to determine the buoyancy profile for the vehicle (100A) to be neutrally buoyant within the slurry (230), when deposited in the settling pond.

A buoyance profile is determined at which the average density of the vehicle (100A) is substantially equal to the density of the slurry (230) into which it is, or will be, at least partially immersed.

Neutral buoyancy is achieved when a buoyant force acting on the vehicle (100B) balances out forces that would otherwise cause the vehicle (100B) to sink or rise in the slurry (230).

Based on the buoyancy profile determined, the device further outputs modifications to be made to the vehicle (100A) so as to enable the vehicle (100A) to conform with, or meet, the neutral buoyancy profile determined and/or provide an optimal operating speed to maintain substantially shear-free traction.

The one or more features include any feature that has an effect on the weight, density and/or buoyancy of the vehicle (100A). For example, the features may include the addition or removal of a mass from the vehicle (100A).

Conversely, the features may include the use of a ballast-like system provided on the vehicle (100A). The system may include one or more tanks located on the vehicle (100A) and configured to hold a volume of material to alter the mass and thereby the buoyancy of the vehicle (100A).

Generally, the one or more features include substituting the scrolls (130) of the vehicle (100A) to alter the buoyancy of the vehicle (100A). For example, in scenarios in which the vehicle (100A) needs to be less buoyant, the vehicle (100A) can be fitted with smaller scrolls (130) having a smaller hollow internal volume. Conversely, in scenarios in which the vehicle (100A) needs to be more buoyant, the vehicle (100A) can be fitted with larger scrolls (130) having a larger hollow internal volume.

The one or more features of the vehicle (100A) may further include modifiable features to provide the vehicle (100A) with an optimal operating speed and/or traction, preferably while maintaining vehicle stability.

The device (210) is further programmed to determine an optimal slurry depth (Δh) for the slurry (230) to be deposited in the settling pond such that the vehicle (100B) is able to maintain substantially shear-free traction along the base layer (240) of the settling pond at an optimal speed determined by the device (210).

The optimal slurry depth (Δh) is the depth at which the scrolls (130B) of the vehicle (100B) maintain substantially shear-free traction with the base layer (240) while being neutrally buoyant within the deposited slurry (230). The optimal slurry depth (Δh) coincides with the depth at which the helical flanges (132) of the scrolls (130B) of the vehicle (100B) are able to maintain engagement with the base layer (240) of the settling pond but not a depth at which a remainder of the scrolls (130B) engage with the base layer (240).

Operations personnel (250) onsite will monitor the slurry depth in the settling pond as the deposited slurry (230) dewaters, and will deposit further slurry (230) as needed to maintain the optimal slurry depth (Δh).

The external processing device (210) can include a computer, a tablet, a smart phone, a smart watch or a PDA, for example. Generally, the device (210) includes at least one display and one or more keys, buttons or switches for the operations personnel (250) to input the slurry properties measured.

The method (300) of enhanced dewatering of a settling pond with the vehicle (100) as shown in FIG. 2 is now described in detail with reference to FIG. 3.

At step 310, the operations personnel (250) measure one or more properties of the slurry sample (220) to determine, or derive, a measurement of at least slurry density and slurry shear strength prior to the slurry (230) being deposited in the settling pond.

The operations personnel (250) inputs the measurement(s) into the external processing device (210).

The operations personnel (250) may further input into the external processing device (210) one or more parameters of the settling pond to receive the slurry (230) and/or properties of the vehicle (100A).

At step 320, the device (210) determines a buoyancy profile for the vehicle (100) to be neutrally buoyant in the slurry (230) when deposited in the settling pond.

At this stage, the method (300) can include one or more further steps as will be described later with reference to the method (400) for modifying the vehicle (100) for enhanced dewatering of the settling pond. The modifications are made so that the vehicle (100) at least conforms with the neutral buoyancy profile determined at step 320.

At step 330, the device (210) determines an optimal slurry depth (Δh) for the slurry (230) to be deposited in the settling pond and for the vehicle (100) to maintain substantially shear-free traction along the base layer (240) of the settling pond.

As indicated above, the optimal slurry depth (Δh) coincides with the depth at which the helical flanges (132) of the scrolls (130B) of the vehicle (100B) are able to maintain engagement with the base layer (240) of the settling pond but not a depth at which a remainder of the scrolls (130B) engage with the base layer (240). This is to prevent re-pulping/re-mixing/re-saturation of the base layer (240) of the settling pond, which would otherwise slow the dewatering process.

The method (400) of modifying a vehicle (100) for enhanced dewatering of a settling pond with the vehicle (100) as shown in FIG. 2 is now described in detail with reference to FIG. 4.

At step 410, the operations personnel (250) measure one or more properties of a slurry sample (220) to determine, or derive, a measurement of at least slurry density and slurry shear strength, prior to the slurry (230) being deposited in the settling pond.

The operations personnel (250) inputs the measurement(s) into the external processing device (210).

The operations personnel (250) may further input into the external processing device (210) one or more parameters of the settling pond to receive the slurry (230) and/or the properties of the vehicle (100) to be modified.

At step 420, the device (210) determines a buoyancy profile for the vehicle (100) to be neutrally buoyant in the slurry (230) when deposited in the settling pond.

At this stage, the device (210) may further suggest modifications to alter the buoyancy of the vehicle (100) so that it conforms with the neutral buoyancy profile determined. The device (210) may further suggest modification to alter the operating speed and/or traction of the vehicle (100).

At step 430, modifications are made to the vehicle (100) to alter at least the buoyancy of the vehicle (100) to conform with the neutral buoyance profile determined at step 420.

The modifications may include substituting the scrolls (130) of the vehicle (100).

For example, in scenarios in which the vehicle (100) needs to be less buoyant, the vehicle (100) can be fitted with smaller scrolls (130) having a smaller hollow internal volume.

Conversely, in scenarios in which the vehicle (100A) needs to be more buoyant, the vehicle (100A) can be fitted with larger scrolls (130) having a larger hollow internal volume.

The modifications may further include increasing or decreasing the number, shape and/or pitch of the helical spiral flange (132) or portions thereof that extend along a length of each scroll (130) to alter the weight of each scroll (130) and thus the buoyancy of the vehicle (100) and/or alter the traction and/or operating speed of the vehicle (100).

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present disclosure. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the disclosure has been described in language more or less specific to structural or methodical features. It is to be understood that the disclosure is not limited to specific features shown or described since the means herein described comprises preferred forms of putting the disclosure into effect. The disclosure is, therefore, claimed in any of its forms or modifications within the proper scope of the appended claims (if any) appropriately interpreted by those skilled in the art.

1-21. (canceled)

22. A system for enhanced dewatering of a settling pond with a mechanical dewatering vehicle, said system comprising:
an external processing device; and
at least one measuring device for measuring properties of a slurry to be deposited in the settling pond,
wherein the external processing device comprises at least one processor and a memory and is programmed to:
determine a buoyancy profile for the vehicle, based on the one or more properties measured and one or more properties of the vehicle, such that the vehicle is neutrally buoyant in the slurry when deposited in the settling pond; and
determine an optimal slurry depth for the slurry to be deposited in the settling pond such that the vehicle is able to maintain substantially shear-free traction as the vehicle traverses the slurry.

23. The system of claim 22, wherein the mechanical dewatering vehicle comprises a vehicle configured to traverse over slurries and slurry-like mediums and provide low ground pressure.

24. The system of claim 23, wherein the mechanical dewatering vehicle is an Archimedes Screw Tractor comprising a chassis and at least two scrolls fitted to the chassis, each scroll having at least one outwardly extending helical spiral flange, said vehicle configured to be propelled by rotation of the scrolls such that the flange on each scroll engages with the slurry through or over which the vehicle traverses.

25. The system of claim 22, wherein the properties measured by the at least one measuring device comprise any one of solids density, liquor density, solids flow rate, liquor flow rate, slurry flow rate, slurry density, and slurry shear strength.

26. The system of claim 22, wherein the properties measured comprise any one of initial settled slurry density, initial shear strength, initial slurry viscosity, initial moisture content, initial particle size distribution and initial residue solids content.

27. The system of claim 22, wherein the vehicle is neutrally buoyant when a buoyant force acting on the vehicle substantially equals forces that would otherwise cause the vehicle to sink or rise in the slurry in the settling pond.

28. The system of claim 22, wherein the substantially shear-free traction comprises traction along a base layer of the settling pond without re-pulping, re-mixing or re-saturation of the base layer.

29. The system of claim 26, wherein the one or more properties of the vehicle considered when determining said buoyancy profile comprise any one of the mass of the vehicle, the volume of the vehicle, a slurry engaging surface area of the vehicle, the dimensions of the scrolls of the vehicle and the volume of the scrolls of the vehicle.

30. The system of claim 29, wherein the one or more of the properties of the vehicle correspond to one or more features of the vehicle capable of being modified so as to enable the vehicle to conform with, or meet, the buoyancy profile determined.

31. The system of claim 30, wherein the one or more features capable of being modified further provide the vehicle with a desired operating speed and traction.

32. The system of claim 30, wherein the one or more features comprise the addition or removal of a mass from the vehicle.

33. The system of claim 30, wherein the one or more features comprise a ballast system configured to adjustably hold a volume of material to alter the mass of the vehicle and thereby the buoyancy of the vehicle.

34. The system of claim 30, wherein the one or more features comprise substituting the scrolls of the vehicle to alter the buoyancy of the vehicle.

35. The system of claim 30, wherein the one or more features comprise modifications to increase or decrease any one of the number, the shape and the pitch of the flange or portions thereof that extend along a length of each said scroll of the vehicle to alter the speed and/or traction of the vehicle and the weight of each scrolls and thus the buoyancy of the vehicle.

36. The system of claim 22, further comprising periodically re-measuring the one or more properties of the slurry to at least monitor when a target slurry density and/or shear strength is achieved or reached.

37. A method of enhanced dewatering of a settling pond with a mechanical dewatering vehicle, said method comprising:
measuring one or more properties of a slurry to be deposited in the settling pond;
determining a buoyancy profile for the vehicle, based on the one or more properties measured and one or more properties of the vehicle, such that the vehicle is neutrally buoyant in the slurry when deposited in the settling pond; and
determining an optimal slurry depth for the slurry to be deposited in the settling pond such that the vehicle is able to maintain substantially shear-free traction as the vehicle traverses the slurry.

38. The method of claim 37, wherein the mechanical dewatering vehicle is an Archimedes Screw Tractor comprising a chassis and at least two scrolls fitted to the chassis, each scroll having at least one outwardly extending helical spiral flange, said vehicle configured to be propelled by rotation of the scrolls such that the flange on each scroll engages with the slurry through or over which the vehicle traverses.

39. The method of claim 37, further comprising periodically re-measuring the one or more properties of the slurry to at least monitory the dewatering of the settling pond.

40. A method of modifying a mechanical dewatering vehicle for enhanced dewatering of a slurry, said method comprising:
measuring one or more properties of the slurry;
determining a buoyancy profile for the vehicle, based on the one or more properties measured and one or more properties of the vehicle, such that the vehicle is neutrally buoyant in the slurry; and
modifying the vehicle, based on the buoyancy profile determined, such that the vehicle is able to maintain substantially shear-free traction as the vehicle traverses the slurry.
